(19) United States
(12) Patent Application Publication
(10) Pub. No.: US 2017/0203756 A1
(43) Pub. Date: Jul. 20, 2017

(54) CONTROLLING THE STABILITY OF A VEHICLE

(71) Applicant: Jaguar Land Rover Limited, Whitley, Coventry, Warwickshire (GB)

(72) Inventor: Tim COTGROVE, Southam, Warwickshire (GB)

(21) Appl. No.: 15/321,602

(22) PCT Filed: May 20, 2015
(86) PCT No.: PCT/EP2015/061098

§ 371 Date: Dec. 22, 2016

(30) Foreign Application Priority Data
Jun. 24, 2014 (GB) 1411178.5

(51) Int. Cl. B60W 30/045; B60G 17/0195; B60G 17/016; B60W 10/18; B60W 10/22

(52) U.S. Cl. CPC B60W 30/045; B60W 10/18; B60W 10/22; B60G 17/0163; B60G 17/0195; B60G 2500/10; B60G 2800/94; B60W 2510/225; B60W 2710/18; B60W 2710/226

(57) ABSTRACT

A method of controlling the stability of a vehicle. The method comprises acquiring an actual value of a vehicle stability parameter and determining a difference between the actual parameter value and a target value of that stability parameter. The method further comprises applying a damper intervention threshold to the difference between the actual and target parameter values, the damper intervention threshold representing a magnitude of the difference between the actual and target parameter values at which damper intervention may be utilized to mitigate a potential over-steer or under-steer condition. The method still further comprises predicting the occurrence of an over-steer or under-steer condition when the damper intervention threshold is exceeded.

### TECHNICAL FIELD

The present invention relates to stability control of a vehicle and particularly, but not exclusively, to controlling the stability of a vehicle by counteracting or mitigating vehicle stability-related conditions, for example, over-steer or under-steer conditions. Aspects of the invention relate to a method, to a system, to a non-transitory computer-readable storage medium, to a vehicle, and to an electronic controller.

### BACKGROUND

It is known that vehicles may include one or more systems or subsystems for performing functions relating to stability control (also referred to or known as, for example, dynamic stability control or electronic stability control) and active damping control (also referred to or know as electronic damping control or active suspension control).

In general terms, a subsystem configured or operable to perform stability control-related functionality may be operable to detect vehicle instability, for example, a potential loss of steering control (i.e., the vehicle is not going in the direction the driver is steering), and to intervene in an effort to correct the instability. This intervention may include, for example, commanding the application of brake torque to one or more wheels of the vehicle, and/or adjusting the drive torque being applied to the vehicle wheels by the vehicle powertrain subsystem. For example, in an instance wherein vehicle instability in the nature of an under-steer condition is detected, the application of brake torque to the inner rear wheel may be commanded in order to generate an opposing over-steer moment that counters the under-steer condition. Conversely, in an instance wherein an over-steer condition is detected, the application of brake torque to the outer front wheel may be commanded in order to generate an opposing under-steer moment that counters the over-steer condition. In any event, the driver's intended direction, which may be determined by a measured steering wheel angle, and the vehicle's actual direction, which may be determined by one or more measured vehicle stability parameters (e.g., lateral acceleration, vehicle rotation or yaw rate, wheel speed, longitudinal acceleration, and roll rate) may be continuously monitored, and when a possible loss of steering control is detected, the stability control subsystem may intervene to mitigate or correct the loss of control.

A subsystem configured to perform active damping-related functionality may be operable to control the vertical movement of the vehicle wheels. Depending on the particular type of damping subsystem, this may include, for example, varying the stiffness or firmness of the dampers or shock absorber (e.g., springs) s of the vehicle, or the actual raising or lowering of the chassis independently at each wheel using an actuator. In operation, the active damping functionality may involve the detection of vehicle body movement, and the control of one or more components of the vehicle suspension, as necessary, to optimize ride quality and vehicle handling by, for example, maintaining the tires in a perpendicular arrangement with the road surface. Vehicle subsystems configured or operable to perform the active-damping functionality may also be used to induce over-steer or under-steer moments on the vehicle similar to those described above with respect to the stability control functionality. More particularly, the active damping subsystem may be configured to adjust the amount of lateral frictional force applied at the axles of the vehicle, and thus, cause an under-steer or over-steer moment to be induced. For example, and in general terms, if the frictional force applied to the front axle is decreased and that applied to the rear axle is increased, an under-steer moment may be induced; while if the frictional force applied to the front axle is increased and that applied to the rear axle is decreased, an over-steer moment may be induced.

One disadvantage of having both stability control and active damping control functionality is that the functionalities are performed independently of each other. As such, the active damping subsystem does not have knowledge of the vehicle handling targets used by the stability control subsystem, and vice versa. Accordingly, in certain instances, it is possible for the functionality of the active damping subsystem to work against that of the stability control subsystem. For example, the stability control subsystem may induce an under-steer or over-steer moment to mitigate, for example, unwanted high yaw or roll rates experienced by the vehicle, by causing brake pressure to be applied to one or more wheels of the vehicle. However, the active damping subsystem may have a damping level set that is more likely to induce an opposing over-steer or under-steer moment that opposes the under-steer or over-steer moment induced by the stability control subsystem. As a result, the stability control subsystem may intervene more strongly than is necessary with the application of a greater brake torque and/or reduction in drive torque than is required, thereby reducing the quality and refinement of the overall stability control.

Accordingly, it is an aim of the present invention to address, for example, one or more of the disadvantages identified above.

### SUMMARY OF THE INVENTION

According to one aspect of the invention, there is provided a method of controlling the stability of a vehicle. In an embodiment, the method comprises: acquiring an actual value of a vehicle stability parameter; determining a difference between the actual parameter value and a target value of the stability parameter; applying a damper intervention threshold to the difference between the actual and target parameter values, the damper intervention threshold representing a magnitude of the difference between the actual and target parameter values at which damper intervention may be utilized to mitigate a potential over-steer or under-steer condition; and predicting the occurrence of an over-steer or under-steer condition when the damper intervention threshold is exceeded. In an embodiment, when the occurrence of an over-steer or under-steer condition is predicted, the method further includes applying active damping control to one or more wheels of the vehicle to counteract the predicted over-steer or under-steer condition.

According to another aspect of the invention, there is provided a non-transitory, computer-readable storage medium storing instructions thereon that when executed by one or more electronic processors causes the one or more processors to carry out the method described herein.

According to yet another aspect of the invention, there is a provided a system for controlling the stability of a vehicle. In an embodiment, the system comprises: an electronic processor having an electrical input for receiving a signal indicative of an actual value of a vehicle stability parameter; and an electronic memory device electrically coupled to the electronic processor and having instructions stored therein. Wherein the processor is configured to access the memory device and execute the instructions stored therein such that it is operable to: determine a difference between the actual parameter value and a target value of the stability parameter; apply a damper intervention threshold to the difference between the actual and target parameter values, the damper intervention threshold representing a magnitude of the difference between the actual and target parameter values at which damper intervention may be utilized to mitigate a potential over-steer or under-steer condition; and predict the occurrence of an over-steer or under-steer condition when the damper intervention threshold is exceeded. In an embodiment, when the occurrence of an over-steer or under-steer condition is predicted, the processor is further operable to command the application of active damping control to one or more wheels of the vehicle to counteract the predicted condition.

According to a further aspect of the invention there is provided a vehicle comprising the system for controlling the stability of the vehicle as described herein.

According to a still further aspect of the invention, there is provided an electronic controller for a vehicle having a storage medium associated therewith storing instructions that when executed by the controller cause the control of the stability of the vehicle in accordance with the method of: acquiring an actual value of a vehicle stability parameter; determining a difference between the actual parameter value and a target value of the stability parameter; applying a damper intervention threshold to the difference between the actual and target parameter values, the damper intervention threshold representing a magnitude of the difference between the actual and target parameter values at which damper intervention may be utilized to mitigate a potential over-steer or under-steer condition; and predicting the occurrence of an over-steer or under-steer condition when the damper intervention threshold is exceeded. In an embodiment, when the occurrence of an over-steer or under-steer condition is predicted, the instructions, when executed by the controller, cause the controller to command the application of active damping control to one or more wheels of the vehicle to counteract the predicted condition.

Optional features of the various aspects of the invention are set out below in the dependent claims.

Embodiments of the present invention may have the advantage that instability of a vehicle in the nature of an over-steer or under-steer condition may mitigated or counteracted, at least initially, by inducing or applying an opposing under-steer or over-steer moment through operation of the active damping subsystem of the vehicle, and without brake intervention typically requested by the stability control subsystem of the vehicle working against the corrective action taken by the active damping system. Accordingly, in an embodiment, stability of the vehicle may be controlled in accordance with a coordinated and integrated strategy that may, for example, result in less brake intervention by the brake and/or powertrain subsystem(s), noise, and brake wear, and that may improve the quality of the stability control of the vehicle.

Within the scope of this application it is expressly intended that the various aspects, embodiments, examples, and alternatives set out in the preceding paragraphs, in the claims, and/or in the following description and drawings, and in particular the individual features thereof, may be taken independently or in any combination. Features described in connection with an embodiment are applicable to all embodiments, unless such feature(s) is/are incompatible.

### BRIEF DESCRIPTION OF THE DRAWINGS

One or more embodiments of the invention will now be described, by way of example only, with reference to the following figures in which:

FIG. 1 is a block diagram illustrating various components of a vehicle;

FIGS. 2A-2C are a flow diagrams depicting various steps of illustrative embodiments of a method of controlling the stability of a vehicle, such as the vehicle illustrated in FIG. 1;

FIG. 3 is a graphical representation of an example wherein an over-steer condition of a vehicle is predicted;

FIG. 4 is a graphical representation of an example wherein an under-steer condition of a vehicle is predicted;

FIG. 5 is an illustration of a vehicle over-steer condition; and

FIG. 6 is an illustration of a vehicle under-steer condition.

### DETAILED DESCRIPTION

The system and method described herein may be used in the control of the stability of a vehicle. In an embodiment, the present system and method acquire an actual value of a stability-related parameter, determine a difference between the acquired value and a target value of the parameter, apply a threshold to the difference between the actual and target parameter values, and predict a potential loss of stability in the nature of, for example, an over-steer or under-steer condition when the threshold is exceeded. When an over-steer or under-steer condition is predicted, the system and method may output one or more electrical signals indicative of the predicted over-steer or under-steer condition, and/or command or effect active damping control to one or more wheels of the vehicle to counteract or mitigate the predicted condition.

References herein to a block such as a function block are to be understood to include reference to software code for performing the function or action specified in which an output is provided responsive to one or more inputs. The code may be in the form of a software routine or function called by a main computer program, or may be code forming part of a flow of code not being a separate routine or function. Reference to function blocks is made for ease of explanation of the manner of operation of a control system according to an embodiment of the present invention.

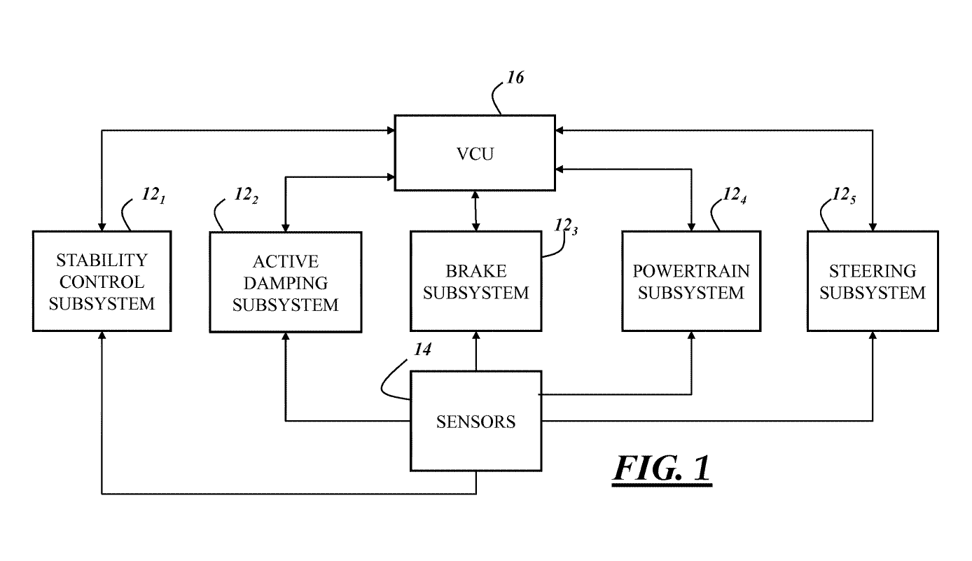

With reference to FIG. 1, there is depicted a block diagram illustrating some of the components of a vehicle 10 with which the present system and method may be used. Although the following description is provided in the context of the particular vehicle illustrated in FIG. 1, it will be appreciated that this vehicle is merely an example and that other vehicles may certainly be used instead. For instance, in various embodiments, the method and system described herein may be used with any type of vehicle having an automatic, manual, or continuously variable transmission, including traditional vehicles, hybrid electric vehicles (HEVs), extended-range electric vehicles (EREVs), battery electrical vehicles (BEVs), passenger cars, sports utility vehicles (SUVs), cross-over vehicles, and trucks, to cite a few possibilities. According to an embodiment, vehicle 10 generally includes a plurality of subsystems 12, a plurality of vehicle sensors 14, and a vehicle control means in the form of a controller 16 (which, in a non-limiting embodiment such as that described below, comprises a vehicle control unit (VCU) (i.e., VCU 16)), among any number of other components, systems, and/or devices not illustrated or otherwise described herein.

Subsystems 12 of vehicle 10 may be configured to perform or control various functions and operations relating to the vehicle and, as illustrated in FIG. 1, may include any number of subsystems, such as, for example, a stability control subsystem 12₁, an active damping subsystem 12₂, a brake subsystem 12₃, a powertrain subsystem 12₄, and a steering subsystem 12₅, to cite only a few possibilities.

Stability control subsystem 12₁—which may also be referred to as a dynamic stability control (DSC) or electronic stability control system—may be configured to perform, or may be configured to contribute to the performance of, a number of important functions relating to the stability of vehicle 10. To that end, and as is well known in the art, stability control subsystem 12₁ may be configured to monitor various operational or vehicle stability parameters of vehicle 10 using, for example, readings, signals, or information received from one or more of sensors 14 and/or other vehicle subsystems 12, and to then command or cause certain actions to be taken if and when it is determined that the stability of vehicle 10 is (or is about to be) compromised (i.e., the vehicle becomes less stable than is desired). More particularly, in an embodiment, subsystem 12₁ may be configured to monitor the attitude of vehicle 10. For example, subsystem 12₁ may receive readings or information from one or more of sensors 14 and/or subsystems 12 described or identified herein (e.g., gyro sensors, vehicle acceleration sensors, etc.) to evaluate the pitch, roll (or roll rate), yaw (or yaw rate), lateral acceleration, and/or vibration (e.g., amplitude and frequency) of vehicle 10 (and/or the vehicle body, in particular), and therefore, the overall attitude, or change in overall attitude, of vehicle 10. Subsystem 12₁ may be further configured to monitor other stability-related parameters, such as, for example and without limitation, the longitudinal acceleration of vehicle 10, the speed of one or more wheels of vehicle 10, and the steering angle (e.g., steering wheel angle) of vehicle 10.

In any event, the information received or determined by stability control system 12₁ may be utilized solely thereby or may alternatively be shared with other subsystems 12 or components (e.g., VCU 16) of vehicle 10 which may use the information to, for example, detect or predict the occurrence of a condition that adversely affects the stability of vehicle 19 (a condition that may result in a loss of stability of the vehicle). If such an occurrence is detected or predicted, corrective or mitigating measures may then be commanded to counteract the occurrence of that condition. For example, and as will be described in greater detail below, in an illustrative embodiment, stability control system 12₁ is configured to predict the occurrence of an over-steer or under-steer condition of vehicle 10 and to then command that certain action be taken by one or more other subsystems of vehicle 10 (e.g., active damping subsystem 12₂, brake subsystem 12₃, and/or one or more other vehicle subsystems) to counteract or mitigate the detected or predicted condition.

It will be appreciated that stability control subsystem 12₁ may be configured to monitor any number or combination of vehicle stability parameters, detect or predict the occurrence of any number of stability-related conditions, and/or command that action be taken by any number or combination of vehicle subsystems to counteract or mitigate a detected or predicted stability-related condition. It will be further appreciated that stability control subsystem 12₁ may be provided according to any number of different embodiments, implementations, or configurations and may include any number of different components, for example, sensors, control units, and/or any other suitable components known in the art. For example, in one embodiment, stability control subsystem 12₁ may be a standalone system comprising a dedicated controller or electronic control unit (ECU) that is configured and operable to perform, or to contribute to the performance of, for example, the functionality described above. In another embodiment, however, some or all of the functionality of stability control subsystem 12₁ may be integrated into or performed by another subsystem of vehicle 10, and a controller or ECU thereof, in particular (a description of a controller is provided below). For example, in an embodiment, some or all of the functionality of stability control subsystem 12₁ may be integrated into brake subsystem 12₃ (e.g., in a brake controller thereof commonly referred to as the anti-lock brake system (ABS) controller), a chassis management subsystem (not shown in FIG. 1), etc. Accordingly, the present invention is not intended to be limited to any particular embodiment(s), implementation(s), or arrangement(s) of stability control subsystem 12₁.

As is well known in the art, active damping subsystem 12₂ may be configured to control the vertical movement of the wheels of vehicle 10 in an effort to maximize or optimize, for example, the ride quality and handling of vehicle 10. In an embodiment, this may be achieved by adjusting the stiffness of one or more of the springs or shock absorbers of the vehicle suspension, or in any number of other ways known in the art. To that end, active damping subsystem 12₂ may be configured to monitor various operational parameters of vehicle 10 using readings, signals, or information received from one or more of vehicle sensors 14 and/or other vehicle subsystems 12, and to then control the vertical movement of one or more wheels of vehicle 10 as necessary and/or as appropriate. As will be described in greater detail below, in an embodiment, active damping subsystem 12₂ may also be configured to receive commands from, for example, stability control subsystem 12₁, in response to the detection or prediction of the occurrence of a vehicle stability-related condition, and to take or cause to be taken certain action in response thereto to counteract or mitigate the predicted condition.

In any event, active damping subsystem 12₂ may take any number of forms, including, but certainly not limited to, one or more of a hydraulic-actuated, electromagnetic-recuperative, solenoid/valve-actuated, or magneto rheological damping system. Active damping subsystem 12₂ may be a standalone system comprising a dedicated controller or electronic control unit (ECU) configured and operable to perform, or to contribute to the performance of, for example, the functionality described above. Alternatively, some or all of the functionality thereof may be integrated into or performed by another subsystem of vehicle 10, and a controller thereof, in particular (e.g., stability control subsystem 12₁, a chassis management subsystem, etc.). Accordingly, the present invention is not intended to be limited to any particular embodiment(s), implementation(s), or arrangement(s) of active damping subsystem 12₂.

As is well known in the art, brake subsystem 12₃ may be configured to generate and control the amount of negative torque (also referred to as “retarding torque” or “braking torque”) that is applied to or exerted on one or more wheels of vehicle 10. The application of a sufficient amount of such negative or retarding torque to the wheel(s) of vehicle 10 results in the slowing down and/or stopping of the progress of vehicle 10, and may also serve to counteract or mitigate the effect an occurrence of a vehicle stability-related condition has on the stability of vehicle 10. Brake subsystem 12₃ may take any number of forms, including, but certainly not limited to, one or a combination of electro-hydraulic, electro-mechanical, regenerative, and brake-by-wire systems. For example, in an embodiment, brake subsystem 12₃ may comprise one or more frictional or regenerative braking devices associated with each wheel of the vehicle that may be independently and separately controlled to apply braking torque to the wheel corresponding thereto. In other words, each wheel may have a braking device associated therewith that may be individually actuated to apply braking torque to the corresponding wheel independent of any braking torque that may be applied at one or more other of the vehicle wheels. Brake subsystem 12₃ may further include a controller or electronic control unit (ECU) that is configured and operable to perform, or to contribute to the performance, of various functions. For example, in an embodiment, brake subsystem 12₃ may include a dedicated brake controller (commonly referred to as an anti-lock brake system (ABS) controller) that is able to individually and separately control the brake torque applied to each wheel of vehicle 10. It will be appreciated, therefore, that the present invention is not intended to be limited to any one particular type of brake subsystem.

In addition to those subsystems described above, vehicle 10 may further comprise any number of other or additional subsystems, such as, for example, a powertrain subsystem 12₄ and a steering subsystem 12₅. For the purposes of this invention, each of the aforementioned subsystems 12, and the functionality corresponding thereto, is conventional in the art. As such, detailed descriptions will not be provided; rather, the structure and function of each identified subsystem 12 will be readily apparent to those having ordinary skill in the art.

One or more of subsystems 12 may be under at least a certain degree of control by VCU 16 (a detailed description of which will be provided below). In such an embodiment, those subsystems 12 are electrically coupled to, and configured for communication with, VCU 16 to provide feedback to VCU 16 relating to operational or operating parameters of vehicle 10, as well as to receive instructions or commands from VCU 16. In an embodiment, some or all of the functionality of one or more of the vehicle subsystems 12 described above may be integrated into VCU 16 such that VCU 16 performs that functionality. For example, in an embodiment, VCU 16 may be configured to perform some or all of the functionality of stability control subsystem 12₁ described above. Alternatively, VCU 16 may be configured to perform functionality other than that described above.

As briefly described above, each subsystem 12 may include a dedicated control means in the form of one or more controllers (e.g., one or more electronic control units (ECUs)) that may be configured to receive and execute instructions or commands provided by VCU 16, and/or to perform or control certain functionality independent from VCU 16 (e.g., the functionality described above for each respective subsystem 12 and some or all of the methodology described below). In such an embodiment, each controller may comprise any suitable ECU, and may include any variety of electronic processing devices, memory devices, input/output (I/O) devices, and/or other known components, and perform various control and/or communication-related functions. In an embodiment, each controller may include an electronic memory device that may store various information, threshold values, sensor readings (e.g., such as those generated by vehicle sensors 14), look-up tables, profiles, or other data structures algorithms, etc. used, for example, in the performance or execution of the methodology described below. The memory device may comprise, for example, a computer-readable, non-transitory medium carrying computer code for controlling one or more components of vehicle 10 to carry out the method(s) described below. Each controller may also include one or more electronic processing devices (e.g., a microprocessor, a microcontroller, an application specific integrated circuit (ASIC), etc.) that executes instructions for software, firmware, programs, algorithms, scripts, applications, etc. that are stored in the corresponding memory device and may govern the method described herein. Each controller may also be electronically connected to other vehicle subsystems, devices, modules, and components (e.g., sensors) via suitable vehicle communications, and may interact with them when or as required. In another embodiment, rather than each subsystem 12 having its own controller, two or more subsystems 12 may alternatively share a single controller, or one or more subsystems 12 may be directly controlled by the VCU 16 itself. In an embodiment wherein a subsystem 12 communicates with VCU 16, other subsystems 12, and/or sensors 14, such communication may be facilitated via any suitable wired or wireless connection, such as, for example, a controller area network (CAN) bus, a system management bus (SMBus), a proprietary communication link, or through some other arrangement known in the art.

In an embodiment, and as with the controllers or ECUs of the subsystems 12 described above, VCU 16 may also comprise any suitable ECU, and may include any variety of electronic processing devices, memory devices, input/output (I/O) devices, and/or other known components, and perform various control and/or communication related functions. In an embodiment, VCU 16 includes an electronic memory device that may store various information, sensor readings (e.g., such as those generated by vehicle sensors 14), look-up tables or other data structures (e.g., such as those used in the performance of the method described below), algorithms (e.g., the algorithms embodied in the method described below), etc. The memory device may comprise a computer-readable, non-transitory medium carrying computer code for controlling one or more components of vehicle 10 to carry out the method(s) described below. The memory device may also store pertinent characteristics and background information pertaining to vehicle 10 and subsystems 12. VCU 16 may also include one or more electronic processing devices (e.g., a microprocessor, a microcontroller, an application specific integrated circuit (ASIC), etc.) that executes instructions for software, firmware, programs, algorithms, scripts, applications, etc. that are stored in the associated memory device and may govern the methods described herein. As described above, VCU 16 may be electronically connected to other vehicle devices, modules, subsystems, and components (e.g., sensors) via suitable vehicle communications, and may interact with them when or as required. In addition to the functionality that may be performed by VCU 16 described elsewhere herein, in an embodiment, VCU 16 may also be responsible for various functionality described above with respect to subsystems 12, especially when those subsystems are not also configured to do so. These are, of course, only some of the possible arrangements, functions, and capabilities of VCU 16, as other embodiments, implementations, or configurations could also be used. Depending on the particular embodiment, VCU 16 may be a stand-alone vehicle electronic module, may be incorporated or included within another vehicle electronic module (e.g., in one or more of the subsystems 12 identified above), or may be otherwise arranged and configured in a manner known in the art. Accordingly, VCU 16 is not limited to any one particular embodiment or arrangement.

For purposes of this disclosure, and notwithstanding the above, it is to be understood that each controller or ECU described herein may comprise a control unit or computational device having one or more electronic processors. Vehicle 10 and/or a subsystem 12 thereof may comprise a single control unit or electronic controller, or alternatively, different functions of the controller(s) may be embodied in, or hosted in, different control units or controllers. As used herein, the term “control unit” will be understood to include both a single control unit or controller and a plurality of control units or controllers collectively operating to provide the required control functionality. A set of instructions could be provided which, when executed, cause said controller(s) or control unit(s) to implement the control techniques described herein (including the method(s) described below). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present invention is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

It will be appreciated that the foregoing represents only some of the possibilities with respect to the particular subsystems of vehicle 10 that may be included, as well as the arrangement of those subsystems with VCU 16. Accordingly, it will be further appreciated that embodiments of vehicle 10 including other or additional subsystems and subsystem/VCU arrangements remain within the spirit and scope of the present invention.

Vehicle sensors 14 may comprise any number of different sensors, components, devices, modules, systems, etc. In an embodiment, some or all of sensors 14 may provide subsystems 12 and/or VCU 16 with information or input that can be used by the present method, and as such, may be electrically coupled (e.g., via wire(s) or wirelessly) to, and configured for communication with, VCU 16, one or more subsystems 12, or some other suitable device of vehicle 10. Sensors 14 may be configured to monitor, sense, detect, measure, or otherwise determine a variety of parameters relating to vehicle 10 and the operation and configuration thereof, and may include, for example and without limitation, any one or more of: wheel speed sensor(s); ambient temperature sensor(s); atmospheric pressure sensor(s); tyre pressure sensor(s); gyro sensor(s) to detect yaw, roll, and pitch of the vehicle; vehicle speed sensor(s); longitudinal acceleration sensor(s); engine torque sensor(s); driveline torque sensor(s); throttle valve sensor(s); steering angle (e.g., steering wheel angle) sensor(s); steering wheel speed sensor(s); gradient sensor(s); lateral acceleration sensor(s); brake pedal position sensor(s); brake pedal pressure sensor(s); accelerator pedal position sensor(s); air suspension sensor(s) (i.e., ride height sensors); wheel position sensor(s); wheel articulation sensor(s); vehicle body vibration sensor(s); water detection sensor(s) (for both proximity and depth of wading events); transfer case HI-LO ratio sensor(s); air intake path sensor(s); vehicle occupancy sensor(s); and longitudinal, lateral, and vertical motion sensor(s), among others known in the art.

The sensors identified above, as well as any other sensors that may provide information that can be used by the present method, may be embodied in hardware, software, firmware, or some combination thereof. Sensors 14 may directly sense or measure the conditions for which they are provided, or they may indirectly evaluate such conditions based on information provided by other sensors, components, devices, modules, systems, etc. Further, these sensors may be directly coupled to VCU 16 and/or to one or more of vehicle subsystems 12, indirectly coupled thereto via other electronic devices, vehicle communications bus, network, etc., or coupled in accordance with some other arrangement known in the art. Some or all of these sensors may be integrated within one or more of the vehicle subsystems 12 identified above, may be standalone components, or may be provided in accordance with some other arrangement. Finally, it is possible for any of the various sensor readings used in the present method to be provided by some other component, module, device, subsystem, etc. of vehicle 10 instead of being directly provided by an actual sensor element. For example, VCU 16 may receive certain information from the ECU of a subsystem 12 rather than directly from a sensor 14. It should be appreciated that the foregoing scenarios represent only some of the possibilities, as vehicle 10 is not limited to any particular sensor(s) or sensor arrangement(s); rather any suitable embodiment may be used.

Again, the preceding description of vehicle 10 and the illustration in FIG. 1 are only intended to illustrate one potential vehicle arrangement, and to do so in a general way. Any number of other vehicle arrangements and/or architectures, including those that differ significantly from the one shown in FIG. 1, may be used instead.

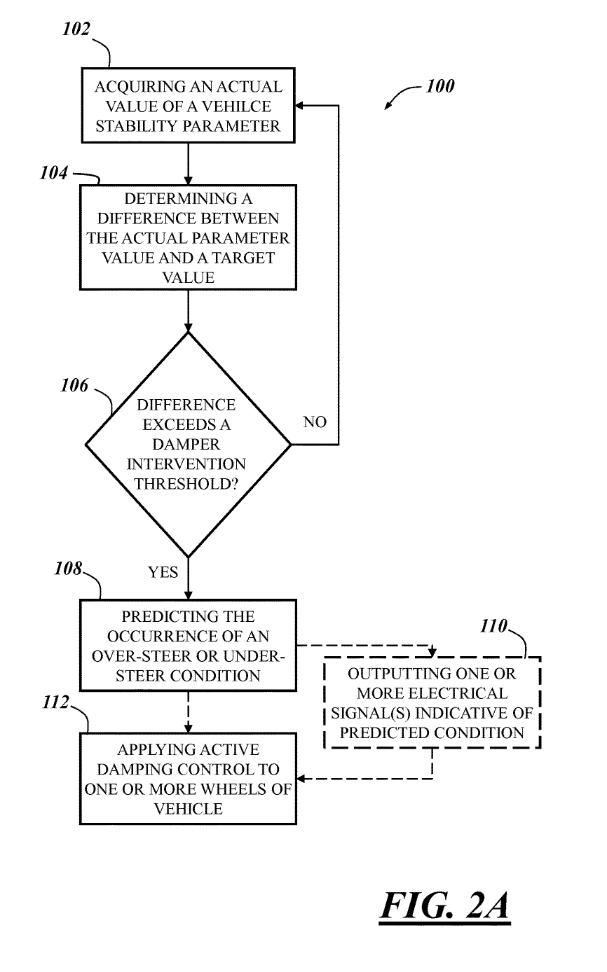

Turning now to FIG. 2A, there is shown an example of a method 100 for controlling the stability of a vehicle. For purposes of illustration and clarity, method 100 will be described in the context of vehicle 10 illustrated in FIG. 1 and described above. It will be appreciated however, that the application of the present methodology is not meant to be limited solely to such an arrangement, but rather method 100 may find application with any number of arrangements (i.e., the steps of method 100 may be performed by subsystems or components of vehicle 10 other than those described below, or vehicle arrangements other than that described above). Additionally, it will be appreciated that unless otherwise noted, the performance of method 100 is not meant to be limited to any one particular order or sequence of steps or to any particular component(s) for performing the steps.

In an embodiment, method 100 comprises a step 102 of acquiring an actual value of a vehicle stability parameter of interest. More specifically, in an embodiment, step 102 comprises receiving one or more electrical signals indicative of a value of the vehicle stability parameter of interest. In another embodiment, step 102 comprises receiving one or more electrical signals indicative of a value of a parameter that may be used by an appropriately configured component or device (e.g., electronic controller or processor) of vehicle 10 to determine (i.e., calculate or derive) the actual value of the vehicle stability parameter of interest. For example, using the received value and one or more previously received values of the parameter, the actual value of a parameter of interest may be calculated or otherwise determined. In any event, in an embodiment wherein step 102 comprises receiving one or more electrical signals, that or those signal(s) may be received from one or more appropriately configured sensors 14 of vehicle 10, one of the subsystems 12 of vehicle 10, or another suitable source. The signal(s) may be received directly from the corresponding sensor(s) and/or subsystems, or indirectly therefrom via, for example, a CAN bus, a SMBus, a proprietary communication link or in another suitable manner.

The vehicle stability parameter for which an actual value is acquired or obtained in step 102 may be one of any number of parameters. These parameters may include, for example and without limitation, the yaw (or yaw rate), roll (or roll rate), body slip (or body slip rate), pitch (or pitch rate), lateral acceleration, and/or longitudinal acceleration of vehicle 10 or the body thereof, or any other suitable stability-related parameter. For purposes of illustration only, the description of method 100 below will be limited to an embodiment wherein the vehicle stability parameter of interest is the yaw rate of the vehicle; though the present invention is not meant to be limited to the use of such a parameter. In such an embodiment, step 102 may comprise receiving one or more electrical signals directly or indirectly from one of sensors 14 of vehicle 10 (e.g., a gyro sensor configured to detect the yaw of the vehicle) that is/are indicative of the yaw or yaw rate of the vehicle, or that may be used by a suitably configured component or device to determine or acquire (e.g., calculate) an actual value of the yaw rate of vehicle 10. In another embodiment, the electrical signal(s) may be acquired from a subsystem 12 of vehicle 10, for example, stability control subsystem 12₁, a chassis management subsystem, or another appropriately configured subsystem.

Accordingly, it will be appreciated in view of the foregoing that the present invention is not intended to be limited to the use of any particular vehicle stability parameter(s) or technique(s) or source(s) from which the actual value of the desired parameter is received in step 102. It will be further appreciated that the above described functionality of step 102 may be performed by any suitable means, for example, an electronic processor that includes an electrical input for receiving electrical signals, including, for example, those described above. In an embodiment, the electronic processor may comprise and electronic processor of stability control subsystem 12₁ or another suitable component of vehicle 10 (e.g., ABS controller of brake subsystem 12₃).

As illustrated in FIG. 2A, following acquisition of the vehicle stability parameter value (e.g., yaw rate) in step 102, method 100 may move to a step 104 of determining a difference between the actual parameter value and a target value. Step 104 may be performed or carried out in a number of ways. For example, in an embodiment, the actual value acquired in step 102 may simply be subtracted from a target value. The target value may be a predetermined, empirically-derived value that is preprogrammed into an appropriate component of vehicle 10 (e.g., a memory device associated with, or at least accessible by, the controller of the vehicle component configured to perform step 104 (e.g., one of vehicle subsystems 12 or VCU 16)), and may be acquired by the vehicle component configured to perform step 104 prior to or during the performance of step 104.

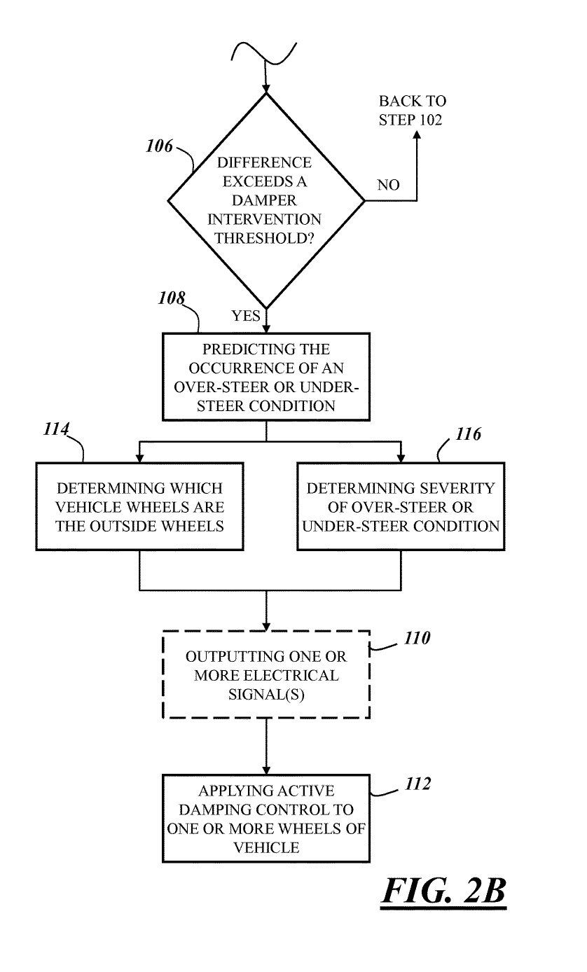

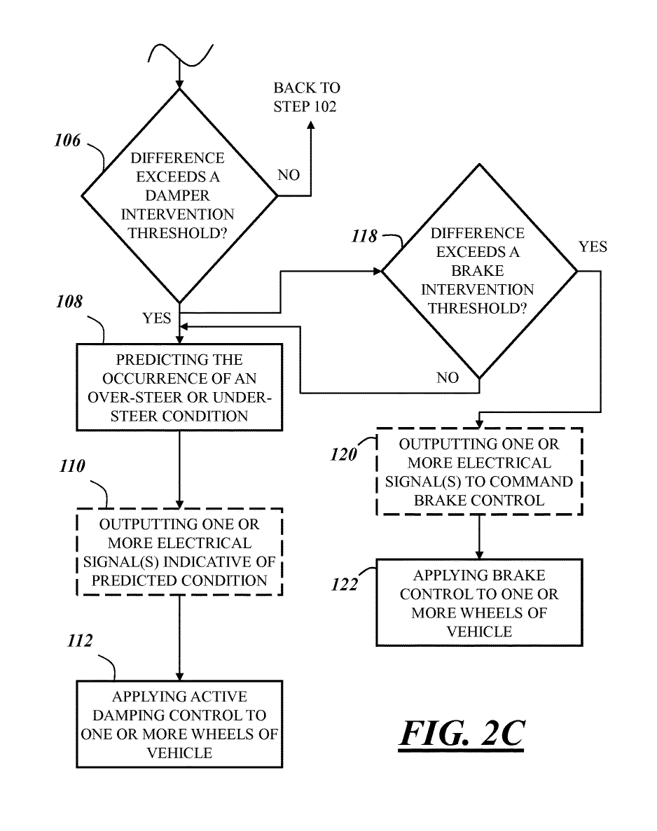

In another embodiment, step 104 may comprise generating or creating a curve or profile that is indicative of the difference between actual and target parameter values over time. FIGS. 3 and 4 each illustrate examples of such an embodiment wherein the yaw rate of the vehicle is the stability parameter of interest. Each of FIGS. 3 and 4 depict a curve or profile 18 representative or indicative of the actual yaw rate of a vehicle over time, an empirically-derived curve or profile 20 representative or indicative of a target yaw rate over time, and a curve 22 representative or indicative of the difference between the actual and target yaw rates of vehicle 10 over time. Accordingly, in such an embodiment, the actual yaw rate of vehicle 10 is continuously monitored during operation of the vehicle and compared or evaluated with a target yaw rate to generate curve 22 that is reflective or representative of the difference between the actual and target yaw rate values over time.

Accordingly, it will be appreciated in view of the foregoing that the present invention is not intended to be limited to any particular technique or way of determining a difference between actual and target values of a parameter of interest in step 104. It will be further appreciated that the above described functionality of step 104 may be performed by any suitable means, for example, the electronic processor of stability control subsystem 12₁ or another suitable component of vehicle 10 (e.g., ABS controller of brake subsystem 12₃).

Once the difference between the actual and target parameter values is determined in step 104, method 100 comprises a step 106 of applying a damper intervention threshold to that difference. In general terms, the damper intervention threshold represents the magnitude of the difference between the actual and target parameter values at which damper intervention may be utilized to mitigate or counteract a vehicle stability-related condition that may adversely affect the stability of vehicle 10 (a condition that may result in a loss of stability of vehicle 10), such as, for example, a vehicle over-steer or under-steer condition. In more specific terms, this threshold may be used to determine when the active damping subsystem 12₂ may be utilized to apply active damping control to one or more wheels of the vehicle to counteract a potential over-steer or under-steer condition. This threshold may be a predetermined, empirically-derived threshold that is preprogrammed into an appropriate component of vehicle 10 (e.g., a memory device associated with, or at least accessible by, the controller of the vehicle component configured to perform step 106 (e.g., one of vehicle subsystems 12 or VCU 16)), and may be acquired by the vehicle component configured to perform step 106. In an embodiment, step 106 comprises simply comparing the difference between the actual and target parameter values determined in step 104 to the damper intervention threshold. In another embodiment, such as that described above wherein step 104 comprises generating a curve representative of the difference between the actual and target values, step 106 may comprise applying the damper threshold to that curve. Each of FIGS. 3 and 4 illustrate such an embodiment wherein a damper threshold THRESH^{damp} is applied to curve 22 corresponding to the difference between the actual and target yaw rate values over time. It will be appreciated that the above described functionality of step 106 may be performed by any suitable means, for example, the electronic processor of stability control subsystem 12₁ or another suitable component of vehicle 10 (e.g., ABS controller of brake subsystem 12₃).

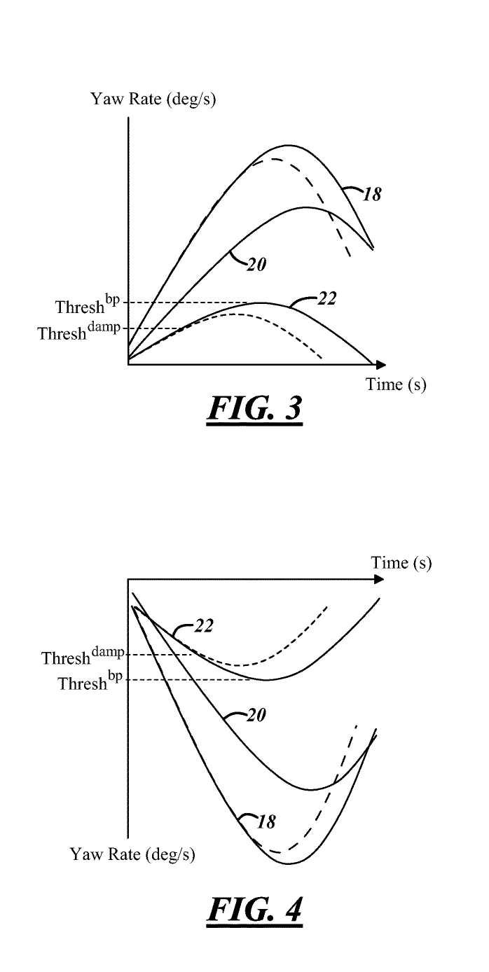

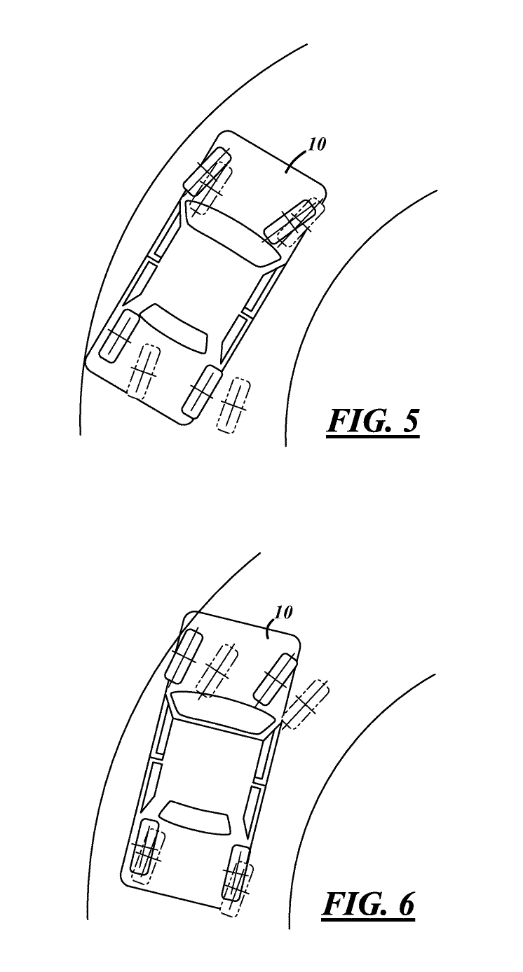

If it is determined in step 106 that the damper threshold is exceeded (or, in an embodiment, met or exceeded), method 100 may proceed to a step 108 of predicting a loss of stability for vehicle 10 in the nature of, for example, the occurrence of an over-steer or under-steer condition; otherwise, method 100 may terminate or loop back to a previous step, for example, step 102. Accordingly, in an embodiment, if the magnitude of the difference between the actual and target yaw rate values for vehicle 10 exceeds a certain threshold value, it may be determined or predicted that vehicle 10 is going to experience either an over-steer or an under-steer condition, depending on the circumstances. More particularly, FIGS. 3 and 5 illustrate an example wherein the damper threshold (THRESH^{damp}) is exceeded and an over-steer condition is predicted (i.e., the actual yaw rate is sufficiently higher than the target rate so as to predict an over-steer condition). Conversely, FIGS. 4 and 6 illustrate an example wherein the damper threshold (THRESH^{damp}) is exceeded and an under-steer condition is predicted (i.e., the actual yaw rate is sufficiently lower than the target rate so as to predict an under-steer condition). It will be appreciated that the above described functionality of step 108 may be performed by any suitable means, for example, the electronic processor of stability control subsystem 12₁ or another suitable component of vehicle 10 (e.g., ABS controller of brake subsystem 12₃).

In an instance wherein the occurrence of an over-steer or under-steer condition is predicted in step 108, method 100 may include any number of additional steps. For example, in an embodiment, method 100 may include a step 110 of outputting one or more electrical signals indicative of the predicted condition. That or those electrical signal(s) may be received by a component or subsystem 12 of vehicle 10, for example, active damping subsystem 12₂, which may interpret the received signal(s) and, as will be described in greater detail below with respect to step 112, apply appropriate active damping control to one or more wheels of vehicle 10 in response thereto to counteract or mitigate the predicted condition. It will be appreciated that the above described functionality of step 110 may be performed by any suitable means, for example, the electronic processor of stability control subsystem 12₁ or another suitable component of vehicle 10 (e.g., ABS controller of brake subsystem 12₃).

It will be appreciated that an embodiment of method 100 that includes step 110 is particularly well-suited for an implementation wherein the component or subsystem 12 of vehicle 10 that predicts the occurrence of a vehicle stability-related condition in step 108 is other than that which applies the damping control to one or more wheels of the vehicle in step 112. One example is an implementation wherein stability control subsystem 12₁, brake subsystem 12₃, or another component of vehicle 10 is configured to perform step 108 (as well as, in an embodiment, steps 102, 104, and 106), and active damping subsystem 12₂ is configured to apply damping control in step 112 as will be described below. In such an embodiment, following the performance of step 110, method 100 may proceed to step 112 described below. However, in an embodiment wherein the same component or subsystem 12 of vehicle 10 is configured to predict the occurrence of an over-steer or under-steer condition in step 108 and apply the necessary active damping control in step 112, for example, active damping subsystem 12₂, step 110 may be omitted from method 100. Instead, following step 108, method 100 may proceed directly to step 112 of applying active damping control to one or more wheels of vehicle 10.

In any event, step 112 of applying active damping control to one or more wheels of vehicle 10 may comprise adjusting one or more characteristics of the components of active damping subsystem 12₂ associated with one or more wheels of vehicle 10. This may include, for example, adjusting (i.e., increasing or decreasing) the stiffness of one or more springs or shock absorbers associated with one or more wheels of vehicle 10. By doing so, the rate at which the weight of vehicle 10 is transferred between the front and rear of vehicle 10 can be adjusted, and therefore, an over-steer or under-steer moment may be induced on vehicle 10 that serves to counteract or mitigate a predicted under-steer or over-steer condition, respectively. Accordingly, in an embodiment, a suitably configured controller of active damping subsystem 12₂, for example, may be configured to command appropriate adjustments to damping components associated with one or more wheels of vehicle 10. For example, and depending on whether an over-steer or under-steer condition is predicted: the stiffness of one or more springs associated with one or both of the “outside” wheels (relative to the intended path of travel of vehicle 10) may be increased, while the stiffness of one or more springs associated with one or both of the “inside” wheels may be decreased or left unchanged; the stiffness of one or more springs associated with one or both of the “inside” wheels may be increased, while the stiffness of one or more springs associated with one or both of the “outside” wheels may be decreased or left unchanged; etc. It will be appreciated that the particular manner in which the adjustments to the damper components are made is dependent, at least in part, upon the particular arrangement or implementation of the active damping subsystem. In any event, it will be further appreciated that particular manners in which such adjustments are made is/are well known in the art, and as such a detailed description of possible manners in which such adjustments are made will not be provided.

The particular nature of the active damping control applied in step 112—for example, which damping components (e.g., springs) to adjust, the magnitude of that or those adjustments, etc. —may depend on upon any number of factors. These factors may include, for example and without limitation, whether the condition predicted in step 108 is an over-steer or under-steer condition, which wheels of vehicle 10 (passenger side or driver's side) are the outer or outside wheels relative to the intended path of travel of the vehicle at the time of the predicted condition (i.e., the wheels that are opposite or away from the direction of a turn are the outside wheels), and/or the severity of the predicted over-steer or under-steer condition, to cite a few possibilities. Accordingly, in an embodiment, method 100 may further include steps for assessing one or more of such factors.

For example, in an embodiment, a determination as to whether the predicted condition is an over-steer or under-steer condition is made in step 108, and method 100 may further comprise, as illustrated in FIG. 2B, a step 114 of determining which wheels of vehicle 10 are the outer or outside wheels, and/or a step 116 of determining the severity of the predicted condition.

In an embodiment, step 114 comprises determining which wheels of vehicle 10 are the outer or outside wheels based on one or more electrical signals received directly or indirectly from one or more vehicle sensors 14 and/or subsystems 12. For example, one or more electrical signal(s) may be received from a steering angle sensor or another suitable sensor 14 of vehicle 10 that is/are indicative of a direction in which vehicle 10 is turning. That or those signals may then be used to determine whether the wheels on the passenger side or driver's side of vehicle 10 are the outer or outside wheels. In another embodiment, one or more electrical signals may be received from, for example, steering subsystem 12₅ that is/are indicative of either a direction in which vehicle 10 is turning or which wheels of vehicle 10 are the outer or outside wheels. In an embodiment wherein step 114 comprises receiving one or more electrical signals, the signal(s) may be received directly from the corresponding sensor(s) and/or subsystems, or indirectly therefrom via, for example, a CAN bus, a SMBus, a proprietary communication link or in another suitable manner.

In an embodiment wherein the component or subsystem 12 of vehicle 10 that performs step 114 (e.g., stability control subsystem 12₁ or brake subsystem 12₃ of vehicle 10) is not the same as that applying the active damping control in step 112 (e.g., active damping subsystem 12₂), the electrical signal(s) output in step 110 described above that are used in step 112 to apply appropriate active damping control may be indicative of both the predicted over-steer or under-steer condition and the determination of which wheels of vehicle 10 are the outer wheels. For example, in an embodiment, an electrical signal in the form of a bit flag may be generated by, for example, the stability control subsystem 12₁ (and a suitably configured controller thereof, in particular) that can be received and interpreted by, for example, active damping subsystem 12₂ (and a suitably configured controller thereof, in particular) to determine which wheels are the outer wheels of vehicle 10 (e.g., logic low or “0” may be indicative of the driver's side wheels being the outer wheels, and logic high or “1” may be indicative of the passenger side wheels being the outer wheels), and to determine the appropriate active damping control to apply in response thereto. Alternatively, in an embodiment wherein the same component or subsystem 12 performs step 114 and step 112 (e.g., active damping subsystem 12₂), the determination of which wheels are the outer wheels may be used by that subsystem in the performance of step 112. In an event, the determination made in step 114 may be used to determine what adjustments, if any, to make to one or more components of active damping subsystem 12₂, for example, which springs associated with which wheel(s) should have their stiffness increased, which should have their stiffness decreased, etc.

Turning to step 116 of determining the severity of the predicted condition, this step may be performed in a number of suitable ways, including, but certainly not limited to, that or those described below. For example, in an embodiment, the particular magnitude of the difference between the actual and target parameter values determined in step 104 may be used to determine the relative severity of the predicted condition (e.g., the greater the magnitude, the more severe the condition). In another embodiment, the rate of change of that difference over time may be used. Accordingly, in such an embodiment, the difference determined in step 104 may be used with one or more previously determined parameter value differences to calculate or derive a rate of change in the difference between the actual and target parameter values.

In either embodiment, the magnitude of the difference determined in step 104 or the rate of change of the difference may be evaluated by, for example and without limitation, comparing it to one or more predetermined, empirically-derived thresholds or ranges preprogrammed into an appropriate component of vehicle 10 (e.g., a memory device associated with, or at least accessible by, the controller of the vehicle component configured to perform step 116 (e.g., one of vehicle subsystems 12 or VCU 16)). In such an embodiment, each threshold or range would correspond to a different degree of severity such that if a particular threshold is exceeded (or, in an embodiment, met or exceeded), the predicted condition is at least as severe as the severity associated with that particular threshold. By way of example, assume, for purposes of illustration only, that an over-steer condition was predicted in step 108 and that there are two thresholds corresponding to different levels or degrees of severity for such a condition—a first corresponding to a mild over-steer condition and a second corresponding to a more pronounced over-steer condition. The magnitude of the difference between the actual and target parameter values determined in step 104 is compared to each of these thresholds, and if the first threshold corresponding to a mild over-steer is exceeded, but the second corresponding to the more pronounced or severe over-steer is not, a determination can be made that the predicted condition comprises a mild over-steer. Conversely, if both the first and second thresholds are exceeded, a determination can be made that the predicted condition is a relatively severe over-steer condition.

In an embodiment wherein the component or subsystem 12 of vehicle 10 that performs step 116 (e.g., stability control subsystem 12₁ or brake subsystem 12₃ of vehicle 10) is not the same as that applying the active damping control in step 112 (e.g., active damping subsystem 12₂), the electrical signal(s) output in step 110 described above that are used in step 112 to apply active damping control may be indicative of both the predicted over-steer or under-steer condition and the severity of that condition. For example, in an embodiment, an electrical signal representative of the severity level (e.g., an integer value, such as, for example and without limitation, “0” for no intervention, “1” for mild over-steer, “2” for mild under-steer, “3” for severe over-steer, and “4” for severe under-steer) may be generated by, for example, the stability control subsystem 12₁ (and a suitably configured controller thereof, in particular), which may be received and interpreted by, for example, active damping subsystem 12₂ (and a suitably configured controller thereof, in particular) to determine the severity of the condition, and to determine the appropriate active damping control to apply. Alternatively, in an embodiment wherein the same component or subsystem 12 performs step 116 and step 112 (e.g., active damping subsystem 12₂), the determination of the severity of the predicted condition may be used by that subsystem in the performance of step 112. In an event, the determination made in step 116 may be used to determine what adjustments, if any, to make to one or more components of active damping subsystem 12₂, for example, which springs associated with which wheel(s) should have their stiffness increased, which should have their stiffness decreased, etc.

While only certain factors that may contribute to the nature in which active damping control is applied in step 112 have been described above, it will be appreciated that other factors may additionally or alternatively be taken into consideration. Accordingly, the present invention is not limited to thus or evaluation of any particular factor(s).

While the description has thus far been with respect to embodiments of method 100 wherein only a damper intervention threshold is applied to the difference between actual and target values of a stability parameter and then active damping control is applied, if necessary, in other embodiments, one or more additional intervention thresholds corresponding to one or more different types of intervention may also be utilized. As such, in an embodiment, method 100 may include a step 118 of applying one or more additional intervention thresholds, simultaneously or one at a time, to the difference determined in step 104, each threshold representing a magnitude of the difference between the actual and target parameter values at which a respective form or type of intervention may be utilized to mitigate or counteract a possible occurrence of a vehicle stability-related condition, such as, for example, an over-steer or under-steer condition. In this way, different types of intervention may be employed depending on the magnitude of the difference determined in step 104 (e.g., if the magnitude is relatively small or low, a first type of intervention (e.g., damper intervention) may be employed, while if the magnitude is relatively large or high, a second type of intervention may additionally or alternatively be employed (e.g., brake intervention, which is described below). In other words, a coordinated and integrated strategy for mitigating or counteracting a vehicle stability-related condition may be employed that may optimize the stability control of the vehicle.

With reference to FIG. 2C, one additional intervention threshold that may be utilized is a brake intervention threshold. In an embodiment, the brake intervention threshold represents the magnitude of the difference between the actual and target parameter values at which brake intervention may be utilized to mitigate or counteract, for example, an over-steer or under-steer condition. This threshold may be used to determine when, for example, the brake subsystem 12₃ or another suitable subsystem 12 or component of vehicle 10 (e.g., powertrain subsystem 12₅) may be utilized to apply brake control to one or more wheels of vehicle 10 to counteract a potential over-steer or under-steer condition. As with the damper intervention threshold described above, the brake intervention threshold may comprise a predetermined, empirically-derived threshold that is preprogrammed into an appropriate component of vehicle 10 (e.g., a memory device associated with, or at least accessible by, the controller of the vehicle component configured to perform step 118 (e.g., one of vehicle subsystems 12 or VCU 16)). In an embodiment, step 118 comprises simply comparing the difference between the actual and target parameter values determined in step 104 to the brake intervention threshold. In another embodiment wherein step 104 comprises generating a curve representative of the difference between the actual and target values, step 118 may comprise applying the brake intervention threshold to that curve. Each of FIGS. 3 and 4 illustrate such an embodiment wherein a brake intervention threshold THRESH^{bp} is applied to curve 22 corresponding to the difference between the actual and target yaw rate values over time. It will be appreciated that the above described functionality of step 118 may be performed by any suitable means, for example of stability control subsystem 12₁ or another suitable component of vehicle 10 (e.g., ABS controller of brake subsystem 12₃).

If it is determined in step 118 that the brake intervention threshold is exceeded (or, in an embodiment, met or exceeded), method 100 may include any number of further steps. For example, in an embodiment, method 100 may include a step 120 of outputting one or more electrical signals to, for example, brake subsystem 12₃ and/or powertrain subsystem 12₅, to command the application of brake control to one or more wheels of vehicle 10. That or those signals may then be interpreted and, in an step 122, the appropriate brake control applied to one or more wheels of vehicle 10 to counteract or mitigate the over-steer or under-steer condition predicted in step 108. It will be appreciated that the above described functionality of step 120 may be performed by any suitable means, for example, the electronic processor of stability control subsystem 12₁ or another suitable component of vehicle 10 (e.g., ABS controller of brake subsystem 12₃).

It will be appreciated that an embodiment of method 100 that includes step 120 is particularly well-suited for an implementation wherein the component or subsystem 12 of vehicle 10 that performs step 118 is other than that which applies the brake control to one or more wheels of the vehicle in step 122. One example is an implementation wherein stability control subsystem 12₁ is configured to perform step 118, and one or both of brake subsystem 12₃ and powertrain subsystem 12₅ is/are configured to apply brake control in step 122 as will be described below. In such an embodiment, following the performance of step 120, method 100 may proceed to step 122 described below. However, in an embodiment wherein the same component or subsystem 12 of vehicle 10 is configured to perform both steps 118 and 122, for example, brake subsystem 12₃, step 120 may be omitted from method 100. Instead, following step 118, method 100 may proceed directly to step 122 of applying brake control to one or more wheels of vehicle 10.

In any event, step 122 of applying brake control to one or more wheels of vehicle 10 may comprise adjusting one or more characteristics of the components of brake subsystem 12₃ and/or powertrain subsystem 12₅ associated with one or more wheels of vehicle 10. This may include, for example, actuating or de-actuating one or more brake devices associated with the wheel(s) of vehicle 10, adjusting (e.g., reducing) the drive torque applied to one or more wheels of vehicle 10 by powertrain subsystem 12₅, or taking some other suitable action. By doing so, an over-steer or under-steer moment may be induced on vehicle 10 that counteracts or mitigates a predicted under-steer or over-steer condition, respectively. As with the active damping control applied in step 112, the particular manner in which brake control may be applied is dependent upon, at least in part, the particular arrangement or implementation of vehicle 10, and, in an embodiment, the brake subsystem thereof, in particular. In any event, it will be appreciated that particular manners in which such control is applied and/or adjustments are made to one or more components of one or more subsystems 12 of vehicle 10 is/are well known in the art and, as such, a detailed description of the manner in which such brake control is applied will not be provided.

As with the active damping control applied in step 112, the particular nature of the brake control applied in step 122 may depend on upon any number of factors. These factors may include, for example and without limitation, those described above with respect to step 112, and therefore, will not be repeated here. Accordingly, in an embodiment, method 100 may further include steps for assessing one or more of such factors. The manner or way in which such factors are assessed or evaluated with respect to the application of brake control in step 122 is the same as, or at least substantially similar to, that described above with respect to the application of active damping control in step 112. Accordingly, for purposes of brevity, such a description will not be repeated but rather is incorporated here by reference.

In any event, in an embodiment, the brake intervention threshold assessed or evaluated in step 118 is greater in magnitude than that of the damper intervention threshold assessed or evaluated in step 106. Accordingly, in such an embodiment, if the damper intervention threshold is exceeded but the brake intervention threshold is not, only active damping control (not brake control) will be applied to one or more wheels of vehicle 10. If however, both thresholds are exceeded (either initially or after the application of active damping control) the intervention may take a number of forms. For example, in one embodiment, only brake control (not active damping control) may be applied to one or more wheels of vehicle 10; in another embodiment a combination of brake control and active damping control may be applied either consecutively or at least partially concurrently.

It will be appreciated in view of the above that a benefit or advantage of at least certain embodiments of the present invention is that an undesirable stability-related condition, for example, an over-steer or under-steer condition, may be counteracted or mitigated without requiring (at least initially) brake intervention using, for example, the brake subsystem of the vehicle. Instead, by allowing for damper intervention ahead of brake intervention, stability of the vehicle may be controlled in accordance with a coordinated and integrated strategy that may, for example, result in less brake subsystem intervention, noise, and brake wear, and that may also improve the quality of the stability control of the vehicle.

It will be understood that the embodiments described above are given by way of example only and are not intended to limit the invention, the scope of which is defined in the appended claims. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Further, the terms “electrically connected” or “electrically coupled” and the variations thereof are intended to encompass both wireless electrical connections and electrical connections made via one or more wires, cables, or conductors (wired connections). Other terms are to be construed using their broadest reasonable meaning unless they are used in a context that requires a different interpretation.

1. A method of controlling the stability of a vehicle, comprising:
acquiring an actual value of a vehicle stability parameter;
determining a difference between the actual parameter value and a target value of the stability parameter;
applying a damper intervention threshold to the difference between the actual and target parameter values, the damper intervention threshold representing a magnitude of the difference between the actual and target parameter values at which damper intervention may be utilized to mitigate a potential over-steer or under-steer condition;
predicting the occurrence of an over-steer or under-steer condition when the damper intervention threshold is exceeded;
applying a brake intervention threshold to the difference between the actual and target parameter values, the brake intervention threshold representing a magnitude of the difference between the actual and target parameter values at which brake intervention may be utilized to mitigate a potential over-steer or under-steer condition; and
when the brake intervention threshold is exceeded, applying brake control to one or more wheels of the vehicle.

2. The method according to claim 1, wherein when the occurrence of an over-steer or under-steer condition is predicted, the method further comprises applying active damping control to one or more wheels of the vehicle to counteract the predicted over-steer or under-steer condition.

3. The method according to claim 1, wherein when the occurrence of an over-steer or under-steer condition is predicted, the method further comprises outputting one or more electrical signals indicative of the predicted over-steer or under-steer condition.

4. The method according to claim 1, further comprising determining the severity of the predicted over-steer or under-steer condition.

5. The method according to claim 4, further comprising outputting one or more electrical signals indicative of the severity of the over-steer or under-steer condition, or basing the severity of the predicted over-steer or under-steer condition on at least one of the magnitude of the difference between the actual and target parameter values, or a rate of change in the difference between the actual and target parameter values over time.

6. (canceled)

7. The method according to claim 1, further comprising determining which wheels of the vehicle are the outside wheels of an intended vehicle path.

8. The method according to claim 1, wherein:
the step of determining the difference between the actual and target parameter values comprises generating a curve that is indicative of the difference between actual and target parameter values over time; and
the applying step comprises applying the damper intervention threshold to the curve.

9. (canceled)

10. The method according to claim 1, comprising at least one of;
the damper intervention threshold being less than the brake intervention threshold; and
when the brake intervention threshold is exceeded, outputting at least one electrical signal to at least one of a brake subsystem or powertrain subsystem of the vehicle to apply brake control to one or more wheels of the vehicle.

11. (canceled)

12. A non-transitory, computer-readable storage medium storing instructions thereon that when executed by one or more electronic processors causes the one or more electronic processors to carry out the method of claim 1.

13. A system for controlling the stability of a vehicle, the system comprising:
an electronic processor having an electrical input for receiving a signal indicative of an actual value of a vehicle stability parameter; and
an electronic memory device electrically coupled to the electronic processor and having instructions stored therein,
wherein the processor is configured to access the memory device and execute the instructions stored therein such that it is operable to:
determine a difference between the actual parameter value and a target value of the stability parameter;
apply a damper intervention threshold to the difference between the actual and target parameter values, the damper intervention threshold representing a magnitude of the difference between the actual and target parameter values at which damper intervention may be utilized to mitigate a potential over-steer or under-steer condition;
predict the occurrence of an over-steer or under-steer condition when the damper intervention threshold is exceeded;
apply a brake intervention threshold to the difference between the actual and target parameter values, the brake intervention threshold representing a magnitude of the difference between the actual and target parameter values at which brake intervention may be utilized to mitigate a potential over-steer or under-steer condition; and
when the brake intervention threshold is exceeded, command the application of brake control to one or more wheels of the vehicle.

14. The system according to claim 13, wherein when the occurrence of an over-steer or under-steer condition is predicted, the processor is operable to command the application of active damping control to one or more wheels of the vehicle to counteract the predicted over-steer or under-steer condition or the processor is operable to determine the severity of the predicted over-steer or under-steer condition.

15. (canceled)

16. The system according to claim 13, wherein the processor is operable to determine the severity of the predicted over-steer or under-steer condition.

17. The system according to claim 16, wherein the processor is operable to output one or more electrical signals indicative of the severity of the predicted over-steer or under-steer condition or wherein the severity of the predicted over-steer or under-steer condition is based on at least one of the magnitude of the difference between the actual and target parameter values, or a rate of change in the difference between the actual and target parameter values over time.

18. (canceled)

19. The system according to claim 13, wherein the processor is further operable to determine which wheels of the vehicle are the outside wheels of an intended vehicle path.

20. The system according to claim 13, wherein:
the processor is operable to determine the difference between the actual and target parameter values by generating a curve that is indicative of the difference between actual and target parameter values over time; and
the processor is operable to apply the damper intervention threshold to the curve.

21. (canceled)

22. The system according to claim 13, comprising at least one of;
when the brake intervention threshold is exceeded, the processor being operable to output at least one electrical signal to at least one of a brake subsystem or powertrain subsystem of the vehicle to command the application of brake control to one or more wheels of the vehicle; and
the damper intervention threshold being less than the brake intervention threshold.

23. (canceled)

24. A vehicle comprising the system of claim 13.

25. An electronic controller for a vehicle having a storage medium associated therewith storing instructions that when executed by the controller causes the control of the stability of the vehicle in accordance with the method of:
acquiring an actual value of a vehicle stability parameter;
determining a difference between the actual parameter value and a target value of the stability parameter;
applying a damper intervention threshold to the difference between the actual and target parameter values, the damper intervention threshold representing a magnitude of the difference between the actual and target parameter values at which damper intervention may be utilized to mitigate a potential over-steer or under-steer condition; and
predicting the occurrence of an over-steer or under-steer condition when the damper intervention threshold is exceeded;
wherein said instructions when executed by the controller further causes the controller to:
apply a brake intervention threshold to the difference between the actual and target parameter values, the brake intervention threshold representing a magnitude of the difference between the actual and target parameter values at which brake intervention may be utilized to mitigate a potential over-steer or under-steer condition; and
when the brake intervention threshold is exceeded, command the application of brake control to one or more wheels of the vehicle.

26. The electronic controller according to claim 25, comprising at least one of:
when the occurrence of an over-steer or under-steer condition is predicted, said instructions when executed by the controller causing the controller to command the application of active damping control to one or more wheels of the vehicle to counteract the predicted over-steer or under-steer condition; and
when the occurrence of an over-steer or under-steer condition is predicted, said instructions when executed by the controller causing the controller to output one or more electrical signals indicative of the predicted over-steer or under-steer condition.

27. (canceled)

28. The electronic controller according to claim 25, wherein said instructions when executed by the controller further causes the controller to determine at least one of:
the severity of the predicted over-steer or under-steer condition, and to output one or more electrical signals indicative of both the predicted over-steer or under-steer condition and the severity thereof; and
which wheels of the vehicle are the outside wheels of an intended vehicle path.

29-30. (canceled)
